(19) United States
(12) Patent Application Publication
(10) Pub. No.: US 2009/0231857 A1
(43) Pub. Date: Sep. 17, 2009

(54) ILLUMINATING DEVICE

(75) Inventors: Naoki ITO, Miyagi-ken (JP); Jun OKAMOTO, Miyagi-ken (JP); Masami AIHARA, Miyagi-ken (JP); Yoshie KAMATA, Fukuoka-ken (JP); Yutaka MORI, Fukuoka-ken (JP)

Correspondence Address: Beyer Law Group LLP, P.O. BOX 1687, Cupertino, CA, 95015-1687, US

(73) Assignee: ALPS ELECTRIC CO., LTD., Tokyo (JP)

(21) Appl. No.: 12/469,601

(22) Filed: May 20, 2009

Related U.S. Application Data
(63) Continuation of application No. PCT/JP2007/072529, filed on Nov. 21, 2007.

(30) Foreign Application Priority Data
Nov. 22, 2006 (JP) 2006-315765
Mar. 30, 2007 (JP) 2007-090741

(51) Int. Cl. F21V 3/00

(52) U.S. Cl. 362/311.14

(57) ABSTRACT

A recess is formed in a substrate. A bare chip, i.e., a light-emitting diode, is installed in the recess and connected to conductive members on the substrate with leads. A light-guiding layer composed of a light-guiding elastomer is disposed on the surface of the substrate. A light-guiding cover layer is bonded on the surface, and the bare chip and the leads are embedded in the elastomer. Light emitted from the bare chip passes through the light-guiding elastomer and is guided along the surface of the substrate to an illumination portion. Since the bare chip and the leads are embedded in the elastomer, failures such as disconnections of the leads under application of external force are suppressed.

### CLAIM OF PRIORITY

This application claims benefit of the Japanese Patent Application No. 2006-315765 filed on Nov. 22, 2006 and Japanese Unexamined Patent Application Publication No. 2007-090741 filed on Mar. 30, 2007, which are hereby incorporated by reference.

### BACKGROUND OF THE INVENTION

1. Field of the Invention

The present invention relates to illuminating devices that illuminate operation units of various electronic appliances. In particular, it relates to a thin illuminating device with a low failure rate under application of external force.

2. Description of the Related Art

Electronic appliances such as audio appliances and portable electronic appliances have light-guiding members that guide light emitted from light-emitting devices such as light-emitting diodes (LEDs) to operation surfaces. Operation buttons formed on the operation surfaces and indicators of fixed characters and numerals engraved in the operation surfaces are illuminated with light that has been guided into the light-guiding members.

In a typical illuminating device, a light-guiding member formed of a resin plate such as an acryl plate is attached on the back of the operation surface of an electronic apparatus, and a light-emitting device is disposed to face a side of the light-guiding member. Light emitted from the light-emitting device enters the light-guiding member from an edge of the light-guiding member, and the light that has passed through the light-guiding member is applied to the operation buttons, indicators, and the like.

A light-emitting device including a semiconductor bare chip having a light-emitting function packaged in a light-guiding casing and conducting terminals protruding from the package has been used as the light-emitting device (refer to Japanese Unexamined Patent Application Publication No. 2001-167655).

According to an existing illuminating device equipped with a light-emitting device that includes a packaged semiconductor, the light-emitting device is thick and a light-guiding member such as an acryl plate needs to be thick to suit the thick light-emitting device. Thus the illuminating device also becomes thick.

Since light emitted from the light-emitting device passes through air and enters the light-guiding member such as an acrylic plate from an edge of the light-guiding member, only a small portion of light emitted from the light-emitting device enters the light-guiding member. Thus, the light use efficiency is low.

According to the existing art, a light-emitting device that emits light of a single color is provided, and light emitted from this light-emitting device is guided to individual portions to be illuminated through the light-guiding member. Thus, the electronic appliances could be illuminated in one color only.

### SUMMARY OF THE INVENTION

The present invention provides an illuminating device that has a thickness smaller than that of the existing art and offers a high light use efficiency.

One aspect of the present invention provides an illuminating device including a substrate, a light-emitting element mounted on the substrate, a light-guiding layer disposed on a surface of the substrate and configured to guide light emitted from the light-emitting element along the surface of the substrate, a cover layer disposed at a position distanced from the surface of the substrate, and a boundary layer disposed between the substrate and the cover layer and configured to divide the surface of the substrate into a plurality of regions. The light-emitting element is a bare chip mounted on the substrate. The light-guiding layer includes a light-guiding elastomer disposed between the substrate and the cover layer. The bare chip is provided inside the elastomer. The elastomer is present in all regions surrounded by the substrate, the cover layer, and the boundary layer.

In this illuminating device, the light-emitting element in a bare chip form is mounted on the substrate, and the light emitted from the bare chip travels inside the elastomer that protects and covers the bare chip is guided to the substrate surface, and is applied to the illumination portion. Thus, compared to existing art in which an illuminating device with a bare chip accommodated in a package is mounted on a substrate, the thickness can be reduced. Moreover, since the light-guiding layer is a light-guiding elastomer, the bare chip enclosed in the light-guiding layer can be protected from external force.

Since light emitted from the bare chip enters the elastomer covering the bare chip, the light use efficiency can be improved compared to the case in which an illuminating device with a bare chip accommodated in a package is mounted on a substrate.

Preferably, the substrate has a recess, and the bare chip is installed in the recess so that the thickness of the illuminating device can be reduced.

Preferably, the bare chip is connected to a conductive member on the substrate with a lead, and the lead is provided inside the elastomer.

Since the lead is buried in the elastomer, application of excessively large stresses to the lead can be prevented even when external force works against the illuminating device. Thus, conduction failures caused by disconnection of the lead and separation of connecting portions between the lead and the bare chip and connecting portions between the lead and the substrate can be prevented.

The elastomer may contain a silicone rubber. Silicone rubbers have high transparency throughout the entire visible light wavelength band (380 nm to 800 nm). Compared to other light-guiding resins, silicone rubbers are less likely to undergo deterioration caused by yellowing, clouding, and discoloration under application of near ultraviolet light (300 nm to 400 nm).

Preferably, at least part of the boundary layer is light-guiding, the cover layer is also light-guiding, and light that has been guided inside the elastomer passes through the light-guiding boundary layer and the cover layer and is emitted outside. In such a case, the boundary layer is composed of a material having a refractive index higher than that of the elastomer constituting the light-guiding layer.

Preferably, a mechanism region surrounded by the light-guiding boundary layer is provided and a switch mechanism configured to operate when pressed through the cover layer is disposed inside the mechanism region. According to this structure, light is emitted outside from the boundary layer surrounding the switch mechanism and the periphery of the switch mechanism can be effectively illuminated.

Preferably, at least part of the boundary layer is non-light-guiding, the bare chip and the elastomer are present in each of the plurality of regions defined by the boundary layer, and the bare chips configured to emit light with different hues are respectively provided in the different regions. In such a case, the non-light-guiding boundary layer is composed of a material having a refractive index lower than that of the elastomer constituting the light-guiding layer.

With the above-described structure, the operation surface of an electronic appliance can be illuminated in different hues depending on the position. A plurality of the bare chips that emit light in different hues may be provided within one area defined by the boundary layer and which bare chips are to emit light may be selected so that the hue of light illuminating the region can be switched.

The elastomer may include a core layer having a high refractive index and cladding layers sandwiching the core layer and having a refractive index lower than that of the core layer, and light emitted from the bare chip may pass through the core layer and may be applied to the light-guiding boundary layer.

When the core layer and the cladding layers are composed of the elastomer, light can be propagated in a wider range in the core layer having a high refractive index.

The illuminating device may further include a light-guiding sealant layer configured to seal the bare chip. The sealant layer may be in contact with the elastomer. Alternatively, the bare chip and the lead may be buried in a light-guiding sealant layer and the sealant layer may be in contact with the elastomer.

According to the above-described structure, the bare chip or the bare chip and the lead are protected with a sealant layer composed of a resin material or the like. Since the sealant layer is further covered with the elastomer that serves as a light-guiding layer, protection of the bare chip and the lead is highly ensured.

According to the present invention, since the bare chip is directly mounted on an illuminating device, the illuminating device can be made thin. Since the bare chip is directly buried in a light-guiding elastomer or the bare chip sealed in a sealant layer is buried in the elastomer, the elastomer alleviates stresses applied when external force is applied. Thus, application of excessively large load on the bare chip and the wiring can be prevented.

### BRIEF DESCRIPTION OF THE DRAWINGS

FIG. 1 is a front view of an operation unit equipped with an illuminating device of a first embodiment of the present invention;

FIG. 2 is an enlarged cross-sectional view of the operation unit shown in FIG. 1 taken along line II-II;

FIG. 3 is an enlarged cross-sectional view showing a part of FIG. 2;

FIG. 4 is a cross-sectional view of an illuminating device according to a second embodiment of the present invention;

FIG. 5 is a cross-sectional view of an illuminating device according to a third embodiment of the present invention;

FIG. 6 is a cross-sectional view of an illuminating device according to a fourth embodiment of the present invention;

FIG. 7 is a cross-sectional view of an illuminating device according to a fifth embodiment of the present invention;

FIG. 8 is a cross-sectional view of an illuminating device according to a sixth embodiment of the present invention; and

FIG. 9 is a cross-sectional view of an illuminating device according to a seventh embodiment of the present invention.

### DESCRIPTION OF THE PREFERRED EMBODIMENTS

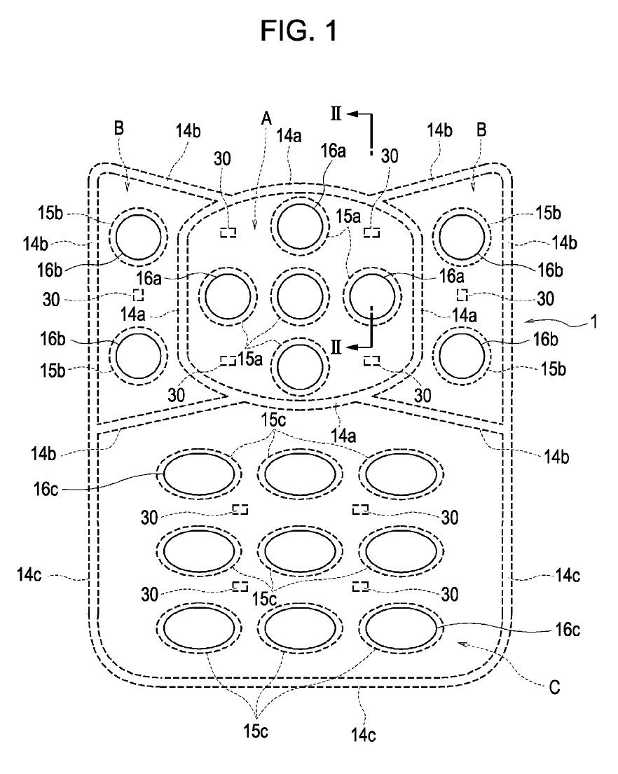

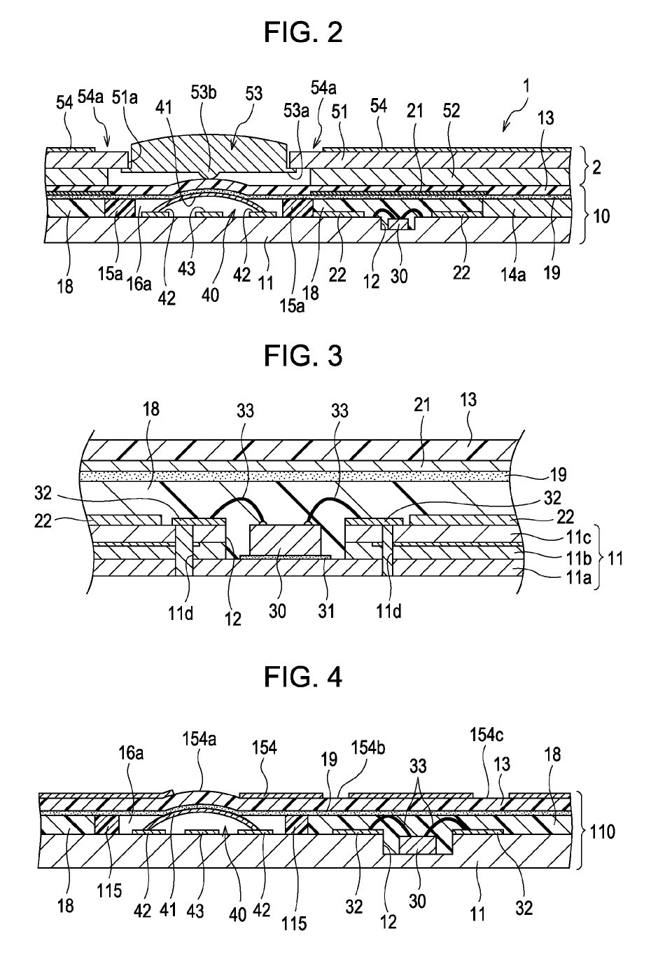

FIG. 1 is a plan view showing an operation unit 1 that uses an illuminating device according to a first embodiment of the present invention. FIG. 2 is a partial cross-sectional view of the operation unit 1 taken along line II-II of FIG. 1. FIG. 3 is a partial enlarged view of FIG. 2.

The operation unit 1 shown in FIG. 1 is provided to the operation surface of a small electronic apparatus such as a cellular phone. In the operation unit 1, an illumination portion occupying part of the area of the operation unit 1 is lighted up. The apparatus can be operated through a plurality of operation buttons in the operation unit 1.

For the purposes of this specification, the phrase “light-guiding” used in “light-guiding layer”, “light-guiding property”, etc., refers to the function of an object that allows light to pass through inside. A “light-guiding layer” or a “light-guiding material” means not only a layer or material that is transparent and has a light transmittance of 100% or near, but also a layer or material that is translucent and has a light transmittance of less than 100% and a layer or material that has a milky or cloudy interior that scatters light while allowing light to pass through.

For the purposes of this specification, an “illumination portion” refers to a portion from which light applied from a light source constituted by a bare chip is emitted outside. When the operation unit 1 is viewed from outside, the illumination portion appears brighter than other portions. The “illumination portion” refers to, for example, a portion where a scattering surface is formed outside the light-guiding layer, the interior of the “light-guiding layer” or “another light-guiding material” in contact with the “light-guiding layer” that has been made milky or cloudy, or the interior of the “light-guiding layer” or “another light-guiding material” that has been made fluorescent by incorporation of a fluorescent material instead of being made milky or cloudy.

As shown in the cross-sectional view of FIG. 2, the operation unit 1 includes an illuminating device 10 and an operation mechanism unit 2 on a surface of the illuminating device 10.

Referring to FIG. 2, the illuminating device 10 includes a substrate 11. As shown in FIG. 3, the substrate 11 is a multilayer substrate having a high stiffness including a plurality of sectional layers 11a, 11b, and 11c that are stacked. Conductive members are formed at interfaces of the sectional layers and at the top of the uppermost sectional layer 11c. A recess 12 is formed in part of the substrate 11. A bare chip 30 of a light-emitting diode serving as a light source is installed in the recess 12.

As shown in FIG. 1, the illuminating device 10 has the recesses 12 formed at a plurality of positions of the substrate 11, and one bare chip 30 is mounted in every recess 12. The bare chip 30 is a light-emitting diode that emits light when supplied with a forward current and includes compound semiconductors with a PN junction. Light with different hues is emitted depending on selection of the materials for the individual compound semiconductor layers. Each bare chip 30 is the semiconductor of an unpackaged light-emitting diode, and, as shown in FIG. 3, is fixed on the bottom of the recess 12 with an adhesive 31.

The light-emitting diodes come in a variety of types including those having Al.Ga.N luminescent layers, Ga.N luminescent layers, and In.Ga.N luminescent layers. The bare chip 30 may be a laser diode instead of the light-emitting diode. In such a case, a phosphor may be incorporated into the illumination portion so that the illumination portion emits light when a laser beam is applied to the illumination portion.

As shown in FIG. 3, conductive members 32 are formed on the surface of the substrate 11. An electrode layer of the bare chip 30 is wire-bonded to the conductive members 32 with leads 33. The conductive members 32 are extended along a wiring pattern formed in the surface of the substrate 11 and connected to another wiring pattern disposed inside the layer via through hole conductive members 11d formed in the substrate 11.

As shown in FIG. 2, the illuminating device 10 has a cover layer 13 at a position distant from the surface of the substrate 11. The cover layer 13 is flexible and has light-guiding property. In this embodiment, the cover layer 13 is a transparent resin sheet composed of polyethylene terephthalate (PET) or the like.

As shown in the cross-sectional view of FIG. 2, a first sectional boundary layer 14a is disposed between the substrate 11 and the cover layer 13. The first sectional boundary layer 14a has no light-guiding property. In other words, the first sectional boundary layer 14a is neither transparent nor translucent and its interior is configured not to transmit light. The first sectional boundary layer 14a is composed of an epoxy resin or the like. Alternatively, the first sectional boundary layer 14a may be formed by making part of the substrate 11 composed of a non-light-guiding material to protrude. Alternatively, the first sectional boundary layer 14a may be composed of a light-guiding material having a refractive index lower than that of an elastomer 18 constituting the light-guiding layer described below. When the first sectional boundary layer 14a is composed of a light-guiding material having a low refractive index, the conduction of light propagating in the elastomer 18 is obstructed by the first sectional boundary layer 14a.

As shown in FIG. 1, the first sectional boundary layer 14a is patterned to surround a particular area. The portion surrounded by the first sectional boundary layer 14a is a first region A. Two second sectional boundary layers 14b are respectively formed on the left and right sides of the first sectional boundary layer 14a. Two second regions B surrounded by the first sectional boundary layer 14a and the second sectional boundary layers 14b are respectively formed on the left and right sides of the first region A. A third sectional boundary layer 14c having a letter-U-shaped pattern is formed under the first region A and the second regions B. A portion with a relatively large area surrounded by part of the first sectional boundary layer 14a, part of the second sectional boundary layers 14b, and the third sectional boundary layer 14c is a third region C.

As described above, the illuminating device 10 has the first sectional boundary layer 14a, the second sectional boundary layers 14b, and the third sectional boundary layer 14c formed between the substrate 11 and the cover layer 13. The sectional boundary layers 14a, 14b, and 14c define the regions A, B, and C.

The second sectional boundary layers 14b and the third sectional boundary layer 14c have the same structure as the first sectional boundary layer 14a, and, for example, are formed by patterning a non-light-guiding epoxy resin or the like. Four bare chips 30 are provided in the first region A, one bare chip 30 is provided in each of the second regions B, and four bare chips 30 are provided in the third region C.

As shown in FIGS. 1 and 2, first light-guiding boundary layers 15a are provided between the substrate 11 and the cover layer 13 in the first region A. Each first light-guiding boundary layer 15a surrounds a circular region and five first light-guiding boundary layers 15a are disposed at five places in the first region A. The circular region surrounded by the first light-guiding boundary layer 15a is a mechanism region 16a. As shown in FIG. 2, a switch mechanism 40 is provided inside the mechanism region 16a.

As shown in FIG. 1, each second region B is provided with two circularly patterned second light-guiding boundary layers 15b. Regions respectively surrounded by the second light-guiding boundary layers 15b are mechanism regions 16b, and a switch mechanism 40 is provided in each mechanism region 16b. The third region C is provided with nine elliptically patterned third light-guiding boundary layers 15c. Regions respectively surrounded by the third light-guiding boundary layers 15c are mechanism regions 16c. A switch mechanism is also provided in each mechanism region 16c.

The first light-guiding boundary layers 15a, the second light-guiding boundary layers 15b, and the third light-guiding boundary layers 15c are composed of a transparent or translucent epoxy resin or the like. In order to guide light propagating in the elastomer 18 constituting the light-guiding layer described below into the interiors of the first light-guiding boundary layers 15a, the second light-guiding boundary layers 15b, and the third light-guiding boundary layers 15c, the refractive indices of the first light-guiding boundary layers 15a, the second light-guiding boundary layers 15b, and the third light-guiding boundary layers 15c are preferably equal to or higher than the refractive index of the elastomer 18.

As shown in FIG. 2, in the first region A, the elastomer 18 that constitutes a light-guiding layer fills the region sandwiched between the upper surface of the substrate 11 and the lower surface of the cover layer 13 and between the inner surface of the first sectional boundary layer 14a and the outer surfaces of the first light-guiding boundary layers 15a. The elastomer 18 is a light-guiding synthetic rubber which is transparent or translucent and contains a filler that scatters light. The light-guiding elastomer 18 is, for example, a silicone rubber. A silicone rubber is a polymer having a main chain formed of siloxane bonds (Si—O—Si) and an organic substituent, such as a methyl group, a phenyl group, or a vinyl group, in a side chain.

Silicone rubbers have high transparency throughout the entire visible light wavelength band (380 nm to 800 nm) used for illumination. Compared to other light-guiding resins, silicone rubbers are less likely to undergo deterioration caused by yellowing, clouding, and discoloration under application of near ultraviolet light (300 nm to 400 nm). Thus, silicone rubbers are suitable for use in illuminating devices.

As shown in FIG. 3, the elastomer 18 covers the surface of the substrate 11 and preferably completely fills the gap between the substrate 11 and the cover layer 13. The elastomer 18 also fills the interior of each recess 12 in the substrate 11. Accordingly, the bare chips 30 are embedded in the elastomer 18, and the leads 33 are also embedded in the elastomer 18. That is, the bare chips 30 and the leads 33 are in direct contact with the elastomer 18 and covered with the elastomer 18. Since the bare chips 30 are embedded in the elastomer 18, application of excessively large stresses onto the bare chips 30 can be prevented even when external force works against the illuminating device 10. Although the leads 33 that connect the bare chips 30 to the conductive members 32 are located between the substrate 11 and the cover layer 13, disconnections of the connecting parts between the leads 33 and the bare chips 30 and connecting parts between the leads 33 and the conductive members 32 can be easily prevented even when external force is applied to the illuminating device 10. This is because the leads 33 are embedded in the elastomer 18.

In the second region B, the elastomer 18 fills the region sandwiched between the upper surface of the substrate 11 and the lower surface of the cover layer 13 and between the outer surface of the first sectional boundary layer 14a, inner surfaces of the second sectional boundary layers 14b, and the outer surfaces of the second light-guiding boundary layers 15b. The bare chips 30 and the leads 33 connected to the bare chips 30 located in the second region B are embedded in the elastomer 18. Similarly, the light-guiding elastomer 18 fills the region sandwiched between the upper surface of the substrate 11 and the lower surface of the cover layer 13 and surrounded by the outer surface of the first sectional boundary layer 14a, the outer surfaces of the second sectional boundary layers 14b, the inner surface of the third sectional boundary layer 14c, and the outer surfaces of the third light-guiding boundary layers 15c. The bare chips 30 and the leads 33 for wiring in the third region C are embedded in the elastomer 18.

The method for making the illuminating device 10 is as follows. The bare chips 30 are respectively fixed, with the adhesive 31, in the recesses 12 formed in the substrate 11, and the electrode layers of the bare chips 30 are connected to the conductive members 32 on the surface of the substrate 11 with the leads 33 by wire bonding. In a step before or after the bare chip 30 mounting step, the first sectional boundary layer 14a, the second sectional boundary layers 14b, and the third sectional boundary layer 14c are formed on the upper surface of the substrate 11 by patterning. This is done by placing a mask with open patterns for forming the sectional boundary layers 14a, 14b, and 14c on the surface of the substrate 11, applying a curable epoxy resin or the like with a squeegee or the like, and thermally curing the applied resin.

Alternatively, a thin hollow needle may be attached to a syringe (injector), a curable epoxy resin or the like may be charged in the syringe, and the sectional boundary layers 14a, 14b, and 14c may be drawn while pushing out the resin from the tip of the needle by increasing the pressure inside the syringe, followed by heating to cure the resin.

The first light-guiding boundary layers 15a, the second light-guiding boundary layers 15b, and the third light-guiding boundary layers 15c are formed at the same time as, before, or after the sectional boundary layers 14a, 14b, and 14c are formed. As with the sectional boundary layers 14a, 14b, and 14c, the light-guiding boundary layers 15a, 15b, and 15c are formed by patterning a resin layer through a mask or direct drawing, and curing the resin.

After the sectional boundary layers 14a, 14b, and 14c and the light-guiding boundary layers 15a, 15b, and 15c are formed on the substrate 11, a liquid resin material is charged in the first region A, the second regions B, and the third region C. The upper surface of the charged resin is made flat and smooth so that the upper surface of the resin substantially levels with the upper surfaces of the sectional boundary layers 14a, 14b, and 14c and the light-guiding boundary layers 15a, 15b, and 15c. Subsequently, the charged resin is heated or irradiated with light energy such as ultraviolet light to be cured and to thereby form a layer of the elastomer 18.

Then reversing plates 41 are disposed in the mechanism regions 16a, 16b, and 16c surrounded by the light-guiding boundary layers 15a, 15b, and 15c. All of the first region A, the second regions B, and the third region C are covered with the same cover layer 13. As shown in FIG. 3, an adhesive layer 19 is formed on the lower surface of the cover layer 13 in advance, so that when the first region A, the second regions B, and the third region C are covered with the cover layer 13, the upper surfaces of the sectional boundary layers 14a, 14b, and 14c and the upper surfaces of the light-guiding layers 15a, 15b, and 15c are bonded to the lower surface of the cover layer 13 through the adhesive layer 19. The adhesive layer 19 is a pressure-sensitive adhesive layer that exhibits adhesiveness or a curable adhesive layer that is cured by application of heat or ultraviolet light.

Alternatively, the reversing plates 41 may be bonded on the cover layer 13 with an adhesive in advance so that when the first region A, the second regions B, and the third region C are covered with this cover layer 13, the reversing plates 41 are also placed in the mechanism regions 16a, 16b, and 16c.

The elastomer 18 easily deforms under external force. Thus, it is difficult to assuredly bond the upper surface of the elastomer 18 to the lower surface of the cover layer 13 through the adhesive layer 19. However, since the sectional boundary layers 14a, 14b, and 14c and the light-guiding boundary layers 15a, 15b, and 15c are relatively hard, it is possible to firmly bond the upper surfaces of the sectional boundary layers 14a, 14b, and 14c and the upper surfaces of the light-guiding boundary layers 15a, 15b, and 15c to the lower surface of the cover layer 13 through the adhesive layer 19. Thus, unintentional separation of the cover layer 13 after assembly can be prevented.

As shown in FIG. 2, in the first region A, a reflective layer 21 is disposed on the lower surface of the cover layer 13 in a portion not overlapping the first light-guiding boundary layers 15a or the mechanism region 16a. The reflective layer 21 is a metal film vapor-deposited on the lower surface of the cover layer 13 or a metal-colored or white coating film coating the lower surface of the cover layer 13. The adhesive layer 19 is formed under the reflective layer 21 (on the surface of the reflective layer 21). Also in the first region A, a reflective layer 22 is formed on the upper surface of the substrate 11 in a portion not overlapping the first light-guiding boundary layers 15a or the mechanism region 16a. As shown in FIG. 3, the reflective layer 22 is formed in regions that do not overlap the recesses 12 where the bare chips 30 are mounted or the conductive members 32 connected to the leads 33. The reflective layer 22 is also formed by vapor-depositing a metal or coating with a metal-colored or white coating film.

In the first region A, light emitted from the bare chips 30 directly reaches inside the light-guiding elastomer 18 without passing through air layers and is guided through the elastomer 18 by being reflected by the reflective layer 21 and the reflective layer 22. Since the reflective layer 21 exists above the elastomer 18, light cannot directly escape upward. Moreover, since the first sectional boundary layer 14a is non-light-guiding or since the first sectional boundary layer 14a is composed of a light-guiding material having a refractive index lower than that of the elastomer 18, light does not pass through the interior of the first sectional boundary layer 14a. Light emitted from the bare chips 30 is mainly applied to the first light-guiding boundary layers 15a.

The same applies for the second regions B and the third region C. Light emitted from the bare chips 30 in the second regions B is mainly applied to the second light-guiding boundary layers 15b, and light emitted from the bare chips 30 in the third region C is mainly applied to the third light-guiding boundary layers 15c.

Light emitted from the bare chips 30 in the first region A is blocked with the first sectional boundary layer 14a and is not guided to the second regions B or the third region C. The same applies to light emitted from the bare chips 30 in the second regions B and to light emitted from the bare chips 30 in the third region C.

Bare chips 30 that emit light of different hues may be disposed in the regions A, B, and C, respectively. In this manner, the first light-guiding boundary layers 15a, the second light-guiding boundary layers 15b, and the third light-guiding boundary layers 15c respectively disposed in the regions A, B, and C can be illuminated with light of hues different from one another. For example, if red light-emitting diodes are used as the bare chips 30 in the first region A, the first light-guiding boundary layer 15a is illuminated in red. If green light-emitting diodes are used as the bare chips 30 in the second regions B, the second light-guiding boundary layers 15b are illuminated in green. If blue light-emitting diodes are used as the bare chips 30 in the third region C, the third light-guiding boundary layers 15c are illuminated in blue.

As shown in FIG. 2, the mechanism region 16a surrounded by the circularly patterned first light-guiding boundary layer 15a has no elastomer 18 charged therein, and the mechanism region 16a remains void. The switch mechanism 40 is provided in the mechanism region 16a. The switch mechanism 40 is provided with the reversing plate 41, which is a dome-shaped metal plate having a springing property and electrical conductivity. The reversing plate 41 is bonded onto the lower surface of the cover layer 13 through the adhesive layer 19. In the mechanism region 16a, an outer electrode 42 and an inner electrode 43 composed of conductive layers are formed on the surface of the substrate 11, and the edge of the reversing plate 41 is disposed on the outer electrode 42. When the cover layer 13 is pressed on the mechanism region 16a, the cover layer 13 deforms, the reversing plate 41 becomes reversed due to the pressure, and the reversing plate 41 contacts both the outer electrode 42 and the inner electrode 43. As a result, the electrical current flows in the outer electrode 42 and the inner electrode 43, and the switch circuit is turned ON.

In the second regions B, the switch mechanisms 40 are provided in the mechanism regions 16b surrounded by the second light-guiding boundary layers 15b. Similarly, in the third region C, switch mechanisms are provided in the mechanism regions 16c surrounded by the third light-guiding boundary layers 15c. The switch mechanisms in the mechanism regions 16c are reversing plates having an elliptical shape.

As shown in FIG. 2, in the operation unit 1, the operation mechanism unit 2 is superimposed on the illuminating device 10. The operation mechanism unit 2 is provided with a panel plate 51 which functions as a protective cover covering the surface of the illuminating device 10. The panel plate 51 is rigid and does not deflect easily. A spacer 52 is interposed between the panel plate 51 and the cover layer 13 of the illuminating device 10. The spacer 52 is a light-guiding film or a light-guiding plastic plate. The panel plate 51 is fixed to the spacer 52 with an adhesive, and the spacer 52 is fixed to the cover layer 13 with an adhesive.

The panel plate 51 has an operation hole 51a. An operation button 53 is provided in the operation hole 51a. A flange 53a is formed at the outer periphery of an end of the operation button 53 and faces the back surface of the panel plate 51. The flange 53a prevents the operation button 53 from coming off from inside the operation hole 51a in the forward direction. The operation button 53 can also move in a downward direction in the figure within the operation hole 51a. A depressing protrusion 53b for depressing the reversing plate 41 is integrally formed on the back surface of the operation button 53.

Operation holes 51a are formed in the panel plate 51 in all portions facing the mechanism regions 16a in the first region A, all portions facing the mechanism regions 16b in the second regions B, and all portions facing the mechanism regions 16c in the third region C. An operation button equivalent to the operation button 53 shown in FIG. 2 is provided in every one of the operation hole 51a. The switch mechanisms in the mechanism regions 16a, 16b, and 16c can be operated with the corresponding operation buttons.

As shown in FIG. 2, a coating film 54 having a hue such as black or brown is formed on the outer surface of the panel plate 51 composed of a light-guiding material. An illumination portion 54a with no coating film 54 is provided at the outer surface of the panel plate 51 in the outer peripheral region of the operation button 53. The illumination portion 54a is ring-shaped, has a particular width, and is provided at the outer periphery of the operation button 53. The illumination portion 54a is formed at every outer peripheral regions of the operation buttons in all regions A, B, and C.

When bare chips 30 are turned ON, light emitted from the bare chips 30 is guided into the elastomer 18 that functions as a light-guiding layer and applied to the first light-guiding boundary layers 15a, the second light-guiding boundary layers 15b, and the third light-guiding boundary layers 15c. As shown in FIG. 2, because the light-guiding cover layer 13, the light-guiding spacer 52, and the light-guiding panel plate 51 are provided on the first light-guiding boundary layers 15a, the light applied to the first light-guiding boundary layers 15a passes through these components and emitted in the forward direction from the illumination portion 54a. As a result, the outer periphery of the operation button 53 is illuminated.

In other words, because the adhesive layer 19 and the cover layer 13 are composed of a material having a refractive index higher than that of the first light-guiding boundary layer 15a, light applied to the interior of the first light-guiding boundary layer 15a from the elastomer 18 is transmitted into the cover layer 13 through the adhesive layer 19. Then light emitted from the cover layer 13 into an air layer thereabove enters the interior of the panel plate 51 and illuminates the illumination portion 54a.

As described above, when the bare chips 30 in the first region A, the bare chips 30 in the second regions B, and the bare chips 30 in the third region C respectively emit light of different hues, the outer peripheries of the operation buttons 53 in the first region A, the outer peripheries of the operation buttons 53 in the second regions B, and the outer peripheries of the operation buttons 53 in the third region C are illuminated in hues different from one another.

The operation buttons 53 may be non-light-guiding or may be composed of a transparent or translucent light-guiding material having a relatively high refractive index. In the case where the operation buttons 53 are composed of a light-guiding material, the outer peripheries of the operation buttons 53 can be illuminated with light of a particular hue due to the light emitted from the first light-guiding boundary layer 15a. In the case where coating films are formed on the surfaces of the operation buttons 53 composed of a light-guiding material and the coating films are partly removed to form patterns such as characters, figures, symbols, and designs, these removed parts indicating characters, figures, symbols, and designs can be illuminated.

In the embodiment shown in FIGS. 1 to 3, the reflective layer 21 on the elastomer 18 may instead be provided on the surface that faces the substrate 11 rather than the adhesive layer 19 or on the surface of the cover layer 13 facing the spacer 52.

Other embodiments of the present invention will now be described. In these embodiments, the constitutional elements equivalent to those of the first embodiment shown in FIGS. 1 to 3 are represented by the same reference symbols and detailed descriptions therefor are omitted.

FIG. 4 is a cross-sectional view showing an illuminating device 110 according to a second embodiment of the present invention.

The illuminating device 110 also has the first sectional boundary layer 14a, the second sectional boundary layers 14b, and the third sectional boundary layer 14c between the substrate 11 and the cover layer 13 to define a plurality of regions A, B, and C. Thus, bare chips 30 that emit light of different hues for different regions can be mounted.

As shown in FIG. 4, a boundary layer 115 surrounding the mechanism region 16a equipped with the switch mechanism 40 has no light-guiding property and is composed of a non-light-guiding epoxy resin or the like as with the sectional boundary layers 14a, 14b, and 14c. Alternatively, the boundary layer 115 may be composed of a material having a refractive index lower than that of the elastomer 18 so that light propagating in the elastomer 18 can be easily reflected at the interface between the elastomer 18 and the boundary layer 115. The cover layer 13 is not provided with the reflective layer 21.

According to the illuminating device 110 shown in FIG. 4, light emitted from the bare chips 30 propagates in the elastomer 18 covering the bare chips 30, passes through the light-guiding cover layer 13, and emitted forward. Thus, the regions A, B, and C can be respectively illuminated with light of particular hues. In such a case, as shown in FIG. 4, a coating film 154 should be formed on the outer surface of the cover layer 13 to cover the front part of the bare chips 30 so that the portions with the bare chips 30 can be prevented from being illuminated excessively brightly compared to other portions. Moreover, illumination portions 154a, 154b, and 154c having no coating film 154 and patterned into characters, figures, symbols, or designs can be formed so that the illumination portions 154a, 154b, and 154c are partially illuminated with light having particular hues.

In such a case, when the refractive index of the cover layer 13 is higher than that of the elastomer 18, light can easily enter the interior of the cover layer 13 from the elastomer 18. Alternatively, a filler may be mixed into the interior of the entire cover layer 13 to render the cover layer 13 milky or cloudy so that the regions A, B, and C are illuminated bright when viewed from outside due to scattering of light inside the cover layer 13. Particles of a phosphor may be incorporated in the cover layer 13 so that when light is guided from the interior of the elastomer 18 to the interior of the cover layer 13, the regions A, B, and C emit fluorescent light. Alternatively, in the cover layer 13, the illumination portions 154a, 154b, and 154c may be partly made milky or cloudy or may partly include a phosphor.

Examples of the phosphor include an oxynitride or oxysulfide (liquid color phosphor) containing at least one element selected from Ti, Zr, Hf, Ta, W, and Mo, other green phosphors, blue phosphors, and any combination of these.

According to the illuminating device 110 shown in FIG. 4, the outer surface of the cover layer 13 can be used as an operation surface which is directly touched with fingers without forming the operation mechanism unit 2. Optionally, the operation mechanism unit 2 shown in FIG. 2 may be provided on the outer surface of the illuminating device 110 shown in FIG. 4. In such a case, no coating film 154 may be formed on the outer surface of the cover layer 13 and the spacer 52, the panel plate 51, and the operation buttons 53 constituting the operation mechanism unit 2 may be illuminated with light that has passed through the cover layer 13. Alternatively, the coating film 54 may be provided on the surface of the panel plate 51 and part of the coating film 54 may be removed to form an illumination portion having a particular pattern.

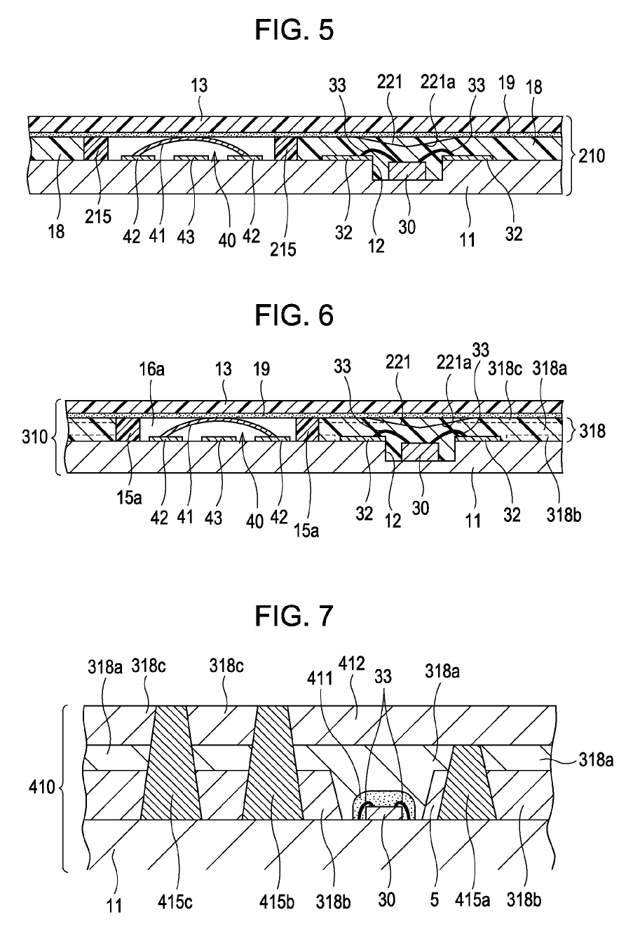

FIG. 5 is a cross-sectional view showing an illuminating device 210 according to a third embodiment of the present invention.

In this illuminating device 210, a reflector 221 is provided at the lower surface of the cover layer 13 in a portion facing the bare chip 30. The lower surface of the reflector 221 is a reflecting surface 221a sloped with respect to the upper surface of the substrate 11. For example, the reflecting surface 221a is a tapered surface sloped in respective directions. In the cross-sectional view of FIG. 5, the section line of the reflecting surface 221a is straight; however, the section line may be curved outward or curved inward.

According to the illuminating device 210, light emitted from the bare chips 30 is reflected at the sloped reflecting surface 221a and scattered around within the elastomer 18. A boundary layer 215 surrounding the mechanism region 16a has a higher refractive index than the elastomer 18 and a light-guiding property so that light can be easily guided inside. Alternatively, the boundary layer 215 may have no light-guiding property or a have a refractive index lower than the elastomer 18 so that light is not easily guided inside. When the boundary layer 215 has light-guiding property and a high refractive index, the boundary layer 215 is illuminated with light scattered inside the elastomer 18. When the boundary layer 215 has no light-guiding property and a low refractive index, the light applied to the interior of the elastomer 18 passes through the cover layer 13 in the region where no reflector 221 is provided and readily emitted in the forward direction.

In the illuminating device 210 shown in FIG. 5 also, the surface of the cover layer 13 can be used as an operation surface fingers can directly touch. Alternatively, the operation mechanism unit 2 shown in FIG. 2 may be superimposed.

FIG. 6 shows an illuminating device 310 according to a fourth embodiment of the present invention.

An elastomer 318 provided in this illuminating device 310 has a light-guiding property and a three-layer structure including a center, which is a core layer 318a, a lower cladding layer 318b thereunder, and an upper cladding layer 318c on the core layer 318a. The core layer 318a is composed of a material having an absolute refractive index larger than those of the lower cladding layer 318b and the upper cladding layer 318c.

The recess 12 in the substrate 11 is filled with the core layer 318a. At least part of the bare chip 30 in the recess 12 is located inside the core layer 318a. The reflector 221 formed as in FIG. 5 has the reflecting surface 221a exposed in the core layer 318a.

The core layer 318a, the lower cladding layer 318b, and the upper cladding layer 318c are all composed of a silicone rubber or the like and their refractive indices are made different by changing the substituents or dispersing microparticles of a metal or semiconductor oxide having a diameter of about several ten nanometers in the layers.

In FIG. 6, the upper end of the bare chip 30 is located in the core layer 318a. Since part of the bare chip 30 is located in the core layer 318a, light emitted from the bare chip 30 can be guided to the core layer 318a with little loss.

In other words, according to the illuminating device 310, light emitted from the bare chip 30 propagates in the core layer 318a while being reflected at the interfaces between the core layer 318a and the upper and lower cladding layers 318b and 318c, is applied to the first light-guiding boundary layer 15a, and illuminates the first light-guiding boundary layer 15a. When part of the upper cladding layer 318c is removed, light is applied to the cover layer 13 from the removed portion, and the cover layer 13 is illuminated through that portion.

For the illuminating device 310 shown in FIG. 6 also, the outer surface of the cover layer 13 may be used as an operation surface or the operation mechanism unit 2 shown in FIG. 2 may be superimposed.

FIG. 7 shows an illuminating device 410 according to a fifth embodiment of the present invention.

The illuminating device 410 has a core layer 318a composed of an elastomer having a high refractive index on the surface of the substrate 11, and a lower cladding layer 318b composed of an elastomer having a low refractive index is disposed between the substrate 11 and the core layer 318a. A hole is formed in the lower cladding layer 318b and serves as a recess. The bare chip 30 is mounted in the recess and is connected to the conductive members on the surface of the substrate 11 with the leads 33.

The bare chip 30 and the leads 33 are covered with a sealant layer 411, and the outer side of the sealant layer 411 is covered with the core layer 318a serving as a light-guiding layer. In other words, the bare chip 30 and the leads 33 are in direct contact with the sealant layer 411, and the sealant layer 411 is in direct contact with the core layer 318a.

The refractive index of the sealant layer 411 is preferably higher than that of the bare chip 30 but equal to or lower than that of the core layer 318a. After the bare chip 30 is mounted on the surface of the substrate 11 and connected to the conductive members on the surface of the substrate 11 via the leads 33, the bare chip 30 is sealed with the sealant layer 411. In this manner, the bare chip 30 and the leads 33 can be protected in the subsequent process. In a further subsequent process, the sealant layer 411 is covered with the core layer 318a composed of an elastomer so that the bare chip 30 and the leads 33 can be protected against pressures from outside during use or the like.

The sealant layer 411 is composed of a synthetic resin or a synthetic rubber. The sealing resin used in the sealant layer 411 is preferably the same compound as the elastomer forming the core layer 318a from the viewpoint of adhesiveness or the like. The sealant layer 411 may be integrally formed with the core layer 318a. Alternatively, other resins may be used. Examples of the resin typically include thermoplastic resins, thermosetting resins, and photocurable resins. Specific examples of the resin include methacrylic resins such as polymethyl methacrylate; styrene resins such as polystyrene and styrene-acrylonitrile copolymers; polycarbonate resins; polyester resins; phenoxy resins; butyral resins; polyvinyl alcohol; cellulose resins such as ethyl cellulose, cellulose acetate, and cellulose acetate butyrate; epoxy resins; phenol resins; and silicone resins. Furthermore, inorganic materials may also be used. For example, an inorganic material obtained by curing one or a combination of solutions obtained by hydrolytic polymerization of a metal alkoxide, a ceramic precursor polymer, and a solution containing metal alkoxide by the sol gel method. For example, an inorganic material containing a siloxane bond may be used. Sealing resins may be used either as a single kind of them or as a mixture of more than one kind in any combination and in any ratio.

The sealant layer 411 may contain a phosphor so that the wavelength of the light source can be converted to a desired wavelength and light can be propagated through the high-refractive-index layer. The amount of the phosphor used is not particularly limited but is typically 0.01 parts by weight or more, preferably 0.1 parts by weight or more, and more preferably 1 part by weight or more, and 100 parts by weight or less, preferably 80 parts by weight or less, and more preferably 60 parts by weight or less per 100 parts by weight of the sealing resin.

The sealant layer 411 may contain components other than the phosphor and the inorganic particles. For example, a stabilizer against processing, oxidation, or heat such as a coloring material for correcting color tone, an antioxidant, or a phosphor process stabilizer, a lightfast stabilizer such as a UV absorber, and a silane coupling agent may be contained. These components may be used alone or in any desired combination of two or more at a desired ratio.

The illuminating device 410 shown in FIG. 7 has boundary layers 415a, 415b, and 415c that penetrate the core layer 318a in a vertical direction. The boundary layers 415a, 415b, and 415c are formed by the same patterns as or different patterns from those of the boundary layers 14a, 14b, and 14c and boundary layers 15a, 15b, and 15c shown in FIG. 1. The boundary layers 415a, 415b, and 415c shown in FIG. 7 are composed of a light-guiding material having a refractive index lower or higher than that of the core layer 318a. When the boundary layers are formed of a material having a lower refractive index, light propagating in the core layer 318a is reflected at the boundary layers. When the boundary layers are formed of a material having a higher refractive index, light propagating in the core layer 318a easily enters the boundary layers.

By selecting the refractive index of the boundary layers as such, the boundary layers can be used as either light-blocking layers or light-guiding paths, and propagation of light can thus be controlled.

According to the illuminating device 410 shown in FIG. 7, the boundary layer 415a and the boundary layer 415b are composed of a material having a low refractive index so that the boundary layers 415a and 415b have a light-blocking function. A cover layer 412 that forms an illumination section is provided on the core layer 318a at the right side of the boundary layer 415b in the drawing. The cover layer 412 is a light-scattering layer containing a filler that scatters light or a phosphor layer containing a phosphor.

The boundary layer 415c having a high refractive index can function as a light-guiding path at the left side of the boundary layer 415b. Upper cladding layers 318c having a low refractive index are formed on the core layer 318a.

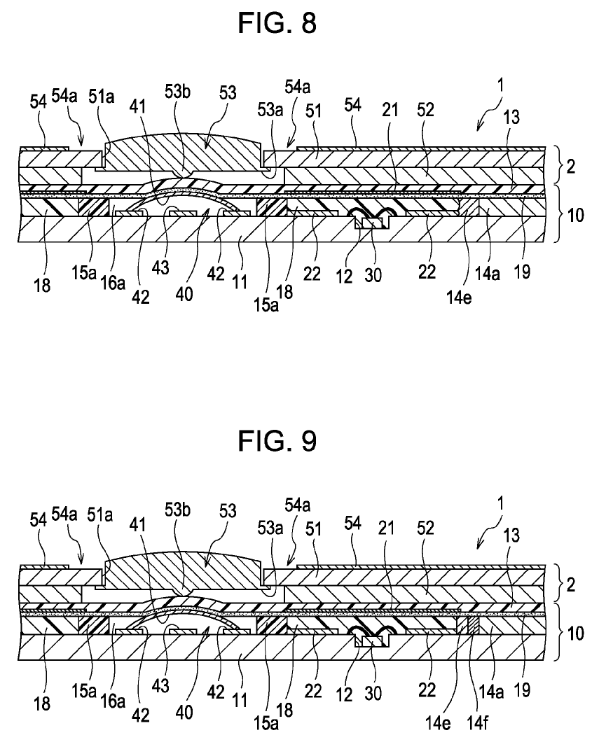

FIG. 8 shows a sixth embodiment of the present invention and FIG. 9 shows a seventh embodiment of the present invention. The sixth embodiment and the seventh embodiment are each a partly modified illuminating device 10 of the first embodiment shown in FIG. 1.

According to the sixth embodiment shown in FIG. 8, a light-absorbing substance is substantially homogeneously dispersed in the first sectional boundary layer 14a and other sectional boundary layers, and a reflective layer 14e is provided at the border between the sectional boundary layer and the elastomer 18. The reflective layer 14e is a layer having a light-reflecting function or a layer having a light-scattering property. When the light-absorbing substance is dispersed in the sectional boundary layer and the reflective layer 14e is provided, light that has reached the sectional boundary layer can be returned to the elastomer 18 functioning as the light-guiding layer so that light can be effectively used.

According to the seventh embodiment shown in FIG. 9, a light-absorbing layer 14f and the reflective layer 14e are provided at the borders between the first sectional boundary layer 14a and other sectional boundary layers and the elastomer 18 so that light can be readily returned to the elastomer 18. The light-absorbing layer 14f is in either a paste form or an ink form in which a light-absorbing substance is dispersed in a binder resin and is gray or black in color.

What is claimed is:

1. An illuminating device comprising:
a substrate;
a light-emitting element mounted on the substrate;
a light-guiding layer disposed on a surface of the substrate and configured to guide light emitted from the light-emitting element along the surface of the substrate;
a cover layer disposed at a position distanced from the surface of the substrate; and
a boundary layer disposed between the substrate and the cover layer and configured to divide the surface of the substrate into a plurality of regions,
wherein the light-emitting element is a bare chip mounted on the substrate,
the light-guiding layer includes a light-guiding elastomer disposed between the substrate and the cover layer,
the bare chip is provided inside the elastomer, and
the elastomer is present in all regions surrounded by the substrate, the cover layer, and the boundary layer.

2. The illuminating device according to claim 1, wherein the substrate has a recess, and the bare chip is installed in the recess.

3. The illuminating device according to claim 1, wherein the bare chip is connected to a conductive member on the substrate with a lead, and the lead is provided inside the elastomer.

4. The illuminating device according to claim 1, wherein the elastomer includes a silicone rubber.

5. The illuminating device according to claim 1, wherein at least part of the boundary layer is light-guiding, the cover layer is also light-guiding, and light that has been guided inside the elastomer passes through the light-guiding boundary layer and the cover layer and is emitted outside.

6. The illuminating device according to claim 5, wherein a mechanism region surrounded by the light-guiding boundary layer is provided and a switch mechanism configured to operate when pressed through the cover layer is disposed inside the mechanism region.

7. The illuminating device according to claim 6, wherein at least part of the boundary layer is non-light-guiding, the bare chip and the elastomer are present in each of the plurality of regions defined by the boundary layer, and the bare chips configured to emit light with different hues are respectively provided in the different regions.

8. The illuminating device according to claim 7, wherein the elastomer includes a core layer having a high refractive index and cladding layers sandwiching the core layer and having a refractive index lower than that of the core layer; and light emitted from the bare chip passes through the core layer and is applied to the light-guiding boundary layer.

9. The illuminating device according to claim 1, further comprising a light-guiding sealant layer configured to seal the bare chip, wherein the sealant layer is in contact with the elastomer.

10. The illuminating device according to claim 3, wherein the bare chip and the lead are embedded in a light-guiding sealant layer, and the sealant layer is in contact with the elastomer.

11. The illuminating device according to claim 5, wherein the boundary layer is composed of a material having a refractive index higher than that of the elastomer.
